(19) United States
(12) Patent Application Publication
(10) Pub. No.: US 2005/0089288 A1
(43) Pub. Date: Apr. 28, 2005

(54) Optical fiber and method of fabricating the same

(75) Inventor: Tatsuhiko Saito, Yokohama-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 10/815,799

(22) Filed: Apr. 2, 2004

(30) Foreign Application Priority Data
Apr. 4, 2003 (JP) P2003-102013

(51) Int. Cl. G02B 6/20; C03B 37/022

(52) U.S. Cl. 385/125; 65/393

(57) ABSTRACT

The present invention relates to an optical fiber, having holes extending along a longitudinal direction thereof, and capable of acquiring an optical transmission characteristic closer to a design value as well as a method of fabricating the optical fiber. The fabrication method comprises the steps of: preparing an optical fiber perform having a specific structure, and a drawing the prepared optical fiber perform with specific conditions. In the preparing step, the prepared optical fiber has a plurality of perform holes intended to serve as the holes. In drawing step, the optical fiber preform is drawn by the a drawing tension of 0.78 (N) or more while pressurizing the inside of the through holes of the optical fiber preform. Thereby, hole deformations of the obtained optical fiber can be prevented, so that it is made possible to achieve an optical transmission characteristic closer to a design value.

### BACKGROUND OF THE INVENTION

1. Field of the Invention

The present invention relates to a micro-structured optical fiber having holes extending along a longitudinal direction thereof, and a method of fabricating the same.

2. Related Background Art

Optical fibers having holes extending along a longitudinal direction thereof (corresponding to a fiber axis direction) include ones called holey fiber or photonic crystal fiber. Hereinafter, such an optical fiber having holes extending along the longitudinal direction is referred to as a micro-structured optical fiber.

In such a micro-structured optical fiber, the difference of mean refractive index between the core region and the cladding region can be adjusted by adjusting the sizes or distribution of the holes in a cross section orthogonal to the longitudinal direction. Therefore, it is possible to obtain a characteristic superior to that of an optical fiber having no hole. For example, in Japanese Patent Application Laid-Open No. 2002-31737, a micro-structured optical fiber having a large negative dispersion and a large effective area at a wavelength of 1.55 (μm) has been proposed. The proposed micro-structured optical fiber has a three-layered cladding region surrounding the core region in order, and in each layer of the cladding region, a plurality of holes are arranged. The above optical transmission characteristic can be obtained by increasing the diameters of the holes in a cross section orthogonal to the longitudinal direction as the holes are located toward increasingly outer position within the three-layered cladding region.

### SUMMARY OF THE INVENTION

The inventors have studied conventional optical communication systems in detail, and as a result, have found problems as follows. Namely, a micro-structured optical fiber is produced by drawing an optical fiber preform having through holes intended to serve as the holes of the optical fiber to be obtained. When an optical fiber preform having through holes is heated and melted for the drawing, the surface tension acts on the interface of each through holes in the tangential directions. When the surface tension acts on the interface of each through holes in this way, the radius direction component of the surface tension increases in proportion to the curvature of each through hole and acts on each through hole so as to collapse it. As a result, the smaller the diameters of the through holes, the more easily the through holes are collapsed under the influences of surface tension, and consequently the holes are collapsed or deformed during the drawing. That is, there have occurred cases where the holes are not formed as designed in the optical fiber after drawing or the holes are deformed.

As described above, the optical transmission characteristic of the micro-structured optical fiber is obtained by adjusting the sizes or distribution of the holes in the cross section orthogonal to the longitudinal direction (corresponding to the fiber axis). Therefore, there has been a case that when no desired holes are formed in the micro-structured optical fiber or the holes are deformed, the optical transmission characteristic widely deviates from the design value.

In order to overcome the above-mentioned problems, it is an object of the present invention to provide an optical fiber having holes extending along the longitudinal direction thereof and an optical characteristic closer to the design value, and a method of fabricating such a micro-structured optical fiber.

The present inventor carried out researches and studies as to how deformations of the through holes of an optical fiber preform intended to serve as the holes of a micro-structured optical fiber are caused when the optical fiber preform is drawn, and has found that when no inside of the through holes are pressurized, the deformations of the holes of the optical fiber preform are caused to the extent of 80 (%) of them, in the region in which the diameter of the optical fiber preform decreases to about 5 (mm), in the course of the process of drawing the optical fiber preform.

That is, in the area inside the heater of the drawing furnace, the temperature of the optical fiber preform is sufficiently high, and therefore the holes are easy to collapse with consideration in view of viscosity. However, the diameters of the holes are large, and hence surface tensions have a slight effect of collapsing the holes. On the contrary, in the area lower than the lower end of the heater, the temperature of the fiber preform is low and the viscosity thereof is high, and hence the holes are hard to collapse whit considering in view of viscosity. However, in this area, the diameters of the holes are very small, and the effects of surface tensions acting on the holes so as to collapse the holes are large. As a result of an investigation, it was found that when comparing effects between viscosity and surface tension, the effect due to viscosity is more predominant for collapsing the holes. This is the reason why the order of 80 (%) of the hole deformations in the optical fiber preform are caused in the area where the diameter of the optical fiber preform is the order of 5 (mm) or more. On further carrying out researches and studies the present invention has been accomplished.

That is, the present invention is directed to a method of fabricating a micro-structured optical fiber in which a plurality of holes extending along a longitudinal direction of the optical fiber. The method of fabricating the optical fiber comprises the steps of: preparing an optical fiber perform having a specific structure; and drawing the optical fiber perform with a predetermined drawing tension. In the preparing step, the optical fiber preform has a plurality of through holes intended to serve as the holes. In the drawing step, the optical fiber preform is drawn with the drawing tension of: 0.78 (N) or more while pressurizing the inside of the through holes of the optical fiber preform. In accordance with the method, the prepared optical fiber preform is drawn while pressurizing the inside of the through holes formed in the optical fiber preform, so that collapsing of the holes is restrained. Further, the optical fiber preform is drawn by a high drawing tension of 0.78 (N) (=80 (gf)) or more, that is, in a low temperature, and thereby the viscosity of the glass is high whereby hole deformations of the drawn perform can also be restrained.

In the method according to the present invention, the drawing tension is preferably 1.18 (N) or more. In the case where the drawing tension is 1.18 (N) (=120 (gf)) or more, the drawing can be carried out at a lower temperature, and thereby hole deformations of the drawn preform can be further restrained.

Furthermore, in the method according to the present invention, in the case of obtaining an optical fiber with the holes each having a diameter d of 2 (μm) or less, the pressure P (kPa) applied to the through holes of the optical fiber preform preferably satisfies the following relation (1). Here, in this specification, the pressure P applied to the through holes means a differential pressure to the atmosphere pressure.
−d+4.5<P<−1.5d+6.8 (1)

At the time that it is started to heat the optical fiber preform in the drawing furnace, the viscosity of the periphery of the through holes reduce because the optical fiber preform is heated and melted. In contrast, the diameters of the through holes are large, and hence influences of the surface tensions are slight. Therefore, when the process of pressurizing the through holes proceeds, the through holes expand under the influence of the pressure applied to the through holes. On the other hand, when the optical fiber preform is drawn and the diameter of the preform becomes smaller, the through holes become smaller, and hence the influences due to the surface tensions become larger and the through holes shrink. In the case of obtaining an optical fiber with the holes each having a diameter d of 2 (μm) or less, expansions and shrinks of the through holes can be balanced by pressurizing the through holes so as to satisfy the above-mentioned relationship (1).

In addition, in the case of obtaining an optical fiber with holes each having a diameter d 2 (μm) or more but 4. (μm) or less, the pressure P (kPa) applied to the through holes of the optical fiber preform preferably satisfies the following relationship (2).
−d+4.5<P<−d+5.8 (2)

In this case, expansions and shrinks of the through holes can be balanced by pressurizing the through holes so as to satisfy the above-mentioned relationship (2).

In the case of obtaining an optical fiber with the holes each having a diameter d of 4, (μm) or more but 6 (μm) or less, the pressure P (kPa) applied to the through holes of the optical fiber preform preferably satisfies the following relationship (3).
−0.2d+1.3<P<−0.4d+3.4 (3).

In this case, expansions and shrinks of the through holes can be balanced by pressurizing the through holes so as to satisfy the above-mentioned relationship (3).

In the case of obtaining an optical fiber with the holes each having a diameter d of 6 (μm) or more, the pressure P (kPa) applied to the inside of the through holes or of the optical fiber preform preferably satisfies the following relationship (4).
0.1<P<1.0 (4).

In this case, expansions and shrinks of the through holes can be balanced by pressurizing the through holes so as to satisfy the above-mentioned relationship (4).

Furthermore, in the case that a fiber diameter after drawing becomes 100 (μm) or less, the optical fiber preform is preferably drawn under the condition that the drawing tension is 1.76 (N) or less. When the drawing tension is 1.76 (N) (=180 (gf)) or less, even in the case that an optical fiber with the diameter of 100 (μm) after drawing is produced by drawing an optical fiber preform, breakage in the obtained optical fiber can be restrained.

In a method for fabricating an optical fiber having an outer diameter of 100 (μm) or less after drawing according to the present invention, in the case of obtaining an optical fiber with the holes each having a diameter d of 2 (μm) or less, the pressure P (kPa) applied to the through holes of the optical fiber preform preferably satisfies the following relationship (5).
−d+4.5<P<1.5d+6.3 (5)

In this case, expansions and shrinks of the through holes can be balanced while restraining fiber breakage by pressurizing the through holes so as to satisfy the above-mentioned relationship (5).

In a method for fabricating an optical fiber having an outer diameter of 100 (μm) or less after drawing according to the present invention, in the case of obtaining an optical fiber with the holes each having a diameter d of 2 (μm) or more but 4 (μm) or less, the pressure P (kPa) applied to the inside of the through holes of the optical fiber preform preferably satisfies the following relationship (6).
−d+4.5<P<−d+5.3 (6)

In this case, expansions and shrinks of the through holes can be balanced while restraining fiber breakage by pressurizing the through holes so as to satisfy the above-mentioned relationship (6).

In a method of fabricating an optical fiber having an outer diameter of 100 (μm) or less after drawing according to the present invention, in the case of obtaining an optical fiber with the holes each having a diameter d of 4 (μm) or more but 6 (μm) or less, the pressure P (kPa) applied to the inside of the through holes of the optical fiber preform satisfies the following relationship (7).
−0.2d+1.3<P<−0.3d+2.5 (7)

In this case, expansions and shrinks of the through holes can be balanced while restraining fiber breakage by pressurizing the through holes so as to satisfy the above-mentioned relationship (7).

Furthermore, in a method of fabricating an optical fiber having an outer diameter of 100 (μm) or less after drawing according to the present invention, in the case of obtaining an optical fiber with the holes each having a diameter d of 6 (μm) or more, the pressure P (kPa) applied to the inside of the through holes of the optical fiber preform satisfies the following relationship (8).
−0.1<P<−0.7 (8)

In this case, expansions and shrinks of the through holes can be balanced while restraining fiber breakage by pressurizing the through holes so as to satisfy the above-mentioned relationship (8).

An optical fiber according to the present invention comprises a core region which extends along a longitudinal direction (corresponding to a fiber axis direction) of the optical fiber, a cladding region provided on an outer periphery of the core region, and a plurality of holes provided so as to extend along the longitudinal direction. The plurality of holes are formed in at least one of the core region and the cladding region, and arranged so as to constitute a layered structure having three or more layers in a cross section orthogonal to the longitudinal direction.

In particular, when the maximum hole diameter and the minimum hole diameter of each of the holes arranged so as to constitute the inner layers except the outermost layer of the layered structure are respectively set to d_{MAX} and d_{MIN}, the mean value of maximum diameters d_{MAX} and the minimum diameters d_{MIN} of each of the holes arranged so as to constitute the inner layers is set to d_{A}, the fist deviation of each of the holes arranged so as to constitute the inner layers is set to D₁ (%) as defined by the following formula (9):

$${D}_{1} = \frac{\vert {d}_{MAX} - {d}_{A} \vert}{{d}_{A}} \times 100 , \qquad ( 9 )$$

the second deviation of each of the holes arranged so as to constitute the inner layers is set to D₂ (%) as defined by the following formula (10):

$${D}_{2} = \frac{\vert {d}_{MIN} - {d}_{A} \vert}{{d}_{A}} \times 100 , \qquad ( 10 )$$

both of the first deviation D₁ and second deviation D₂ of each of the holes arranged so as to constitute the inner layers are 10 (%) or less.

When the plurality of holes constitute the layered structure, the geometric formation of the holes arranged so as to constitute the inner layers except the outermost layer of the layered structure exerts an influence on the optical transmission characteristic more than the geometric formation of the holes arranged so as to constitute the outermost layer. Thus, the optical transmission characteristic of the obtained optical fiber can be made closer to the design value because the first deviations D₁ and second deviations D₂ of the hole arranged so as to constitute the inner layers are respectively 10 (%) or less.

Furthermore, in the optical fiber according to the present invention having the above-mentioned structure, when the maximum hole diameter and the minimum hole diameter of each of the whole holes are respectively set to d_{MAX} and d_{MIN}, the mean value of the maximum diameters d_{MAX} and the minimum diameters d_{MIN} of each of the whole holes is set to δ_{A}, the fist deviation of each of the whole holes is set to Δ₁ (%) as defined by the following formula (11):

$${Δ}_{1} = \frac{\vert {d}_{MAX} - {δ}_{A} \vert}{{δ}_{A}} \times 100 , \qquad ( 11 )$$

the second deviation of each of the whole holes is set to δ₂ (%) as defined by the following formula (12):

$${Δ}_{2} = \frac{\vert {d}_{MIN} - {δ}_{A} \vert}{{δ}_{A}} \times 100 , \qquad ( 12 )$$

both of the first deviation δ₁ and second deviation δ₂ of each of the whole holes is 10 (%) or less. In this case, both of the first deviation δ₁ and the second deviation δ₂ of each of the whole holes including the holes arranged so as to constitute the outermost layer are 10 (%) or less. Thus, the optical transmission characteristic of the obtained optical fiber can be made closer to the design value.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1A is a view showing a cross sectional structure, of a micro-structured optical fiber of one embodiment of according to the present invention; and

FIG. 1B is a cross sectional view of one of the holes;

FIG. 2 is a view showing a cross sectional structure, of an optical fiber preform to be the micro-structured optical fiber of FIGS. 1A and 1B, orthogonal to the longitudinal direction thereof;

FIG. 3 is a schematic view showing a configuration of a drawing apparatus for drawing the optical fiber perform of FIG. 2;

FIG. 9 is a graph showing the optimum range of pressure applied to the through holes provided in the optical fiber perform;

FIG. 5 is an electron microscope photograph showing a cross sectional structure of the micro-structured optical fiber obtained by drawing the optical fiber preform by the drawing tension of 0.59 (N);

FIG. 6 is an electron microscope photograph showing a cross sectional structure of the micro-structured optical fiber obtained by drawing the optical fiber preform by the drawing tension of 1.08 (N);

FIG. 7 is an electron microscope photograph showing a cross sectional structure of the micro-structured optical fiber obtained by drawing the optical fiber preform by the drawing tension of 1.32 (N);

FIG. 8 is an electron microscope photograph showing a cross sectional structure of the micro-structured optical fiber obtained by drawing the optical fiber preform by the drawing tension of 1.47 (N);

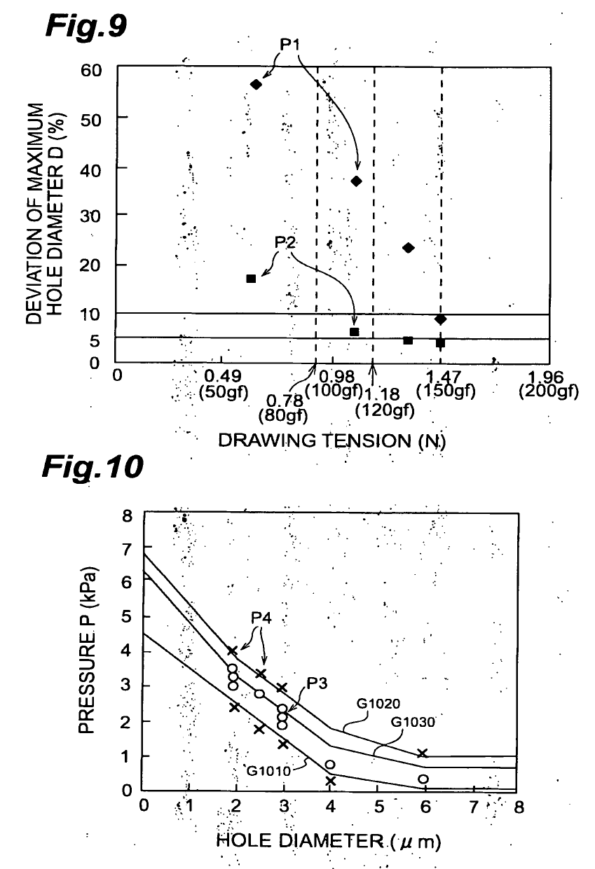

FIG. 9 is a graph showing the relationship between the drawing tension and the deviation of maximum hole diameter; and

FIG. 10 is a graph showing the relationship between the optimum pressurizing range and the hole diameter.

### DETAILED DESCRIPTION OF THE PREFERRED EMBODIMENTS

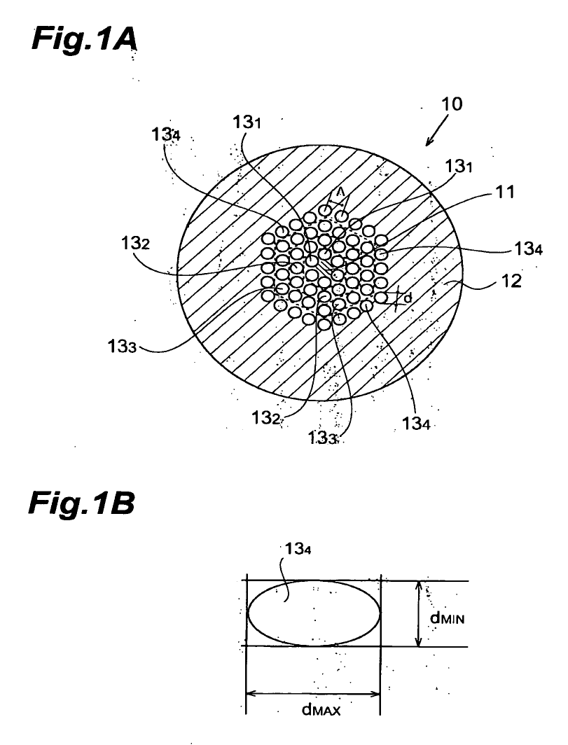

In the following, embodiments of an optical fiber, and a method of fabricating the same according to the present invention will be explained in detail with reference to FIGS. 1A, 1B, 2 to 10. In the explanation of the drawings, constituents identical to each other will be referred to with numerals identical to each other without repeating their overlapping descriptions.

At first, a micro-structured optical fiber in which a plurality of holes is provided along a longitudinal direction (corresponding to a fiber axis) of the optical fiber will be explained. FIG. 1A is a view showing a cross sectional structure, of the micro-structured optical fiber 10 according to the present embodiment, orthogonal to the longitudinal direction. The micro-structured optical fiber 10 comprises a core region 11 extending along the longitudinal direction, and a cladding region 12 surrounding the outer periphery of the core region 11.

In the cladding region 12, a plurality of holes 13₁, 13₂, 13₃, and 13₄ extending along the longitudinal direction of the micro-structured optical fiber 10 is formed around the core region 11. As shown in FIG. 1A, the holes 13₁ to 13₄ are arranged so as to constitute a layered structure having four layers with hexagonal lattice forms around the core region 11. Dotted lines in FIG. 1A are drawn in order to show that the distribution of the holes 13₁ to 13₄ constitute the layered structure, and are not actually formed. In this connection, while the layers are designated as first, second, third, and fourth layers respectively in order from the innermost layer to the outermost layer, holes constituting the layers are designated as holes 13₁, 13₂, 13₃, and 13₄ respectively. The holes 13₁ to 13₄ are arranged so that d/Λ is 0.5 or more, where d (μm) represents the diameter of each of the holes, and Λ (μm) represents the center-to-center distance between adjacent holes. When one of the holes (e.g. holes 13₄) is deviated from a circular form whit perfect roundness as shown in FIG. 1B, the diameter d may be the mean value of the maximum hole diameter (e.g. the length of the major axis d_{MAX} (μm) and minimum hole diameter (e.g. the length of the minor axis) d_{MIN} (μm) of the hole.

Furthermore, at the case that the first deviation D₁ (%) of each of the holes 13₁ to 13₃ is defined by the following formula (13):

$${D}_{1} = \frac{\vert {d}_{MAX} - {d}_{A} \vert}{{d}_{A}} \times 100 , \qquad ( 13 )$$

and the second deviation D₂ (%) of each of the holes 13₁ to 13₃ is defined by the following formula (14):

$${D}_{2} = \frac{\vert {d}_{MIN} - {d}_{A} \vert}{{d}_{A}} \times 100 , \qquad ( 14 )$$

when the maximum hole diameter deviation D (%) of each Of the holes 13₁ to 13₃ is assumed as the larger one out of the associated first deviation D₁ and the associated second deviation D₂, the maximum hole diameter deviation D of each of the holes 13₁ to 13₃ arranged so as to constitute the inner layers except the outermost layer is 10 (%) or less. In other words, regarding to each hole, both of the first deviation D₁ and the second deviation D₂ are 10 (%) or less.

In the formulas (13) and (14), d_{A} (μm) is the mean value of the maximum hole diameters d_{MAX} and the minimum hole diameters d_{MIN} of the holes 13₁, 13₂, and 13₃ constituting the inner layers.

Since the maximum hole diameter deviations D of each of the holes 13₁ to 13₃ is 10 (%) or less (namely, the deformations of the holes 13₁ to 13₃ are little) as described above, an optical transmission characteristic such as a chromatic dispersion characteristics of the micro-structured optical fiber 10 is closer to the design value. That is why the geometric formation of the holes 13₁ to 13₃ arranged so as to constitute the inner layers exert a greater influence on the optical transmission characteristic of the micro-structured optical fiber 10 than the geometric formation of the holes 13₄ arranged so as to constitute the outermost layer.

Furthermore, in the micro-structured optical fiber 10 the holes 13₁ to 13₄ are provided in the cladding region 12, so that the mean refractive index of the cladding region 12 is less than that in the case where the cladding region 12 contains no holes 13₁ to 13₄. Therefore, the relative refractive index difference between the core region 11 and the cladding region 12 is larger than that in the case where any hole is not formed in the cladding region 12.

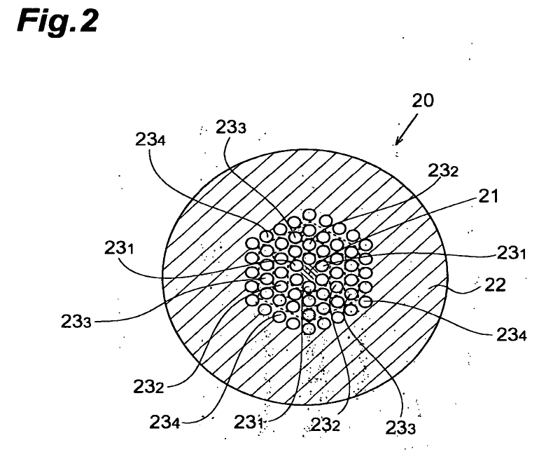

Next, a method of fabricating the micro-structured optical fiber 10 will be explained. At first, an optical fiber preform 20 intended to serve as the micro-structured optical fiber 10 is prepared. FIG. 2 is a view showing a cross sectional structure, of the optical fiber preform 20, orthogonal to the longitudinal direction. The optical fiber preform 20 comprises, as shown in FIG. 2, a first region 21 intended to serve as the core region 11, and a second region 22 intended to serve as the cladding region 12. It is assumed that the first region 21 and the second region 22 have the same composition. In the second region 22, through holes 23₁, 23₂, 23₃, and 23₄ intended to serve as the holes 13₁, 13₂, 13₃, and 13₄ are formed. The through holes 23₁ to 23₄ are arranged, as shown in FIG. 2, with the layered structure with four layers each having a hexagonal lattice form around the first region 21 in a cross section orthogonal to the longitudinal direction. The dotted lines in FIG. 2 are described, like the dotted lines in FIG. 1A, to show that the through holes 23₁ to 23₄ constitute the layered structure.

The optical fiber preform 20 is obtained by forming at first the first region 21 and the second region 22 by a VAD method, MCVD method, OVD method, or the like, by dehydrating and sintering the obtained soot perform so as to be a transparent glass preform, and by forming the through holes 23₁ to 23₄ in the second region 22. The through holes 23₁ to 23₄ may be formed with a drill for example. The diameter of the optical fiber preform 20 is not limited to a particular value, and is, for example, about 40 mm to 70 mm. This optical fiber preform 20 is elongated by an elongating apparatus so that the diameter of it becomes, for example, 25 mm, and then transferred to the drawing process.

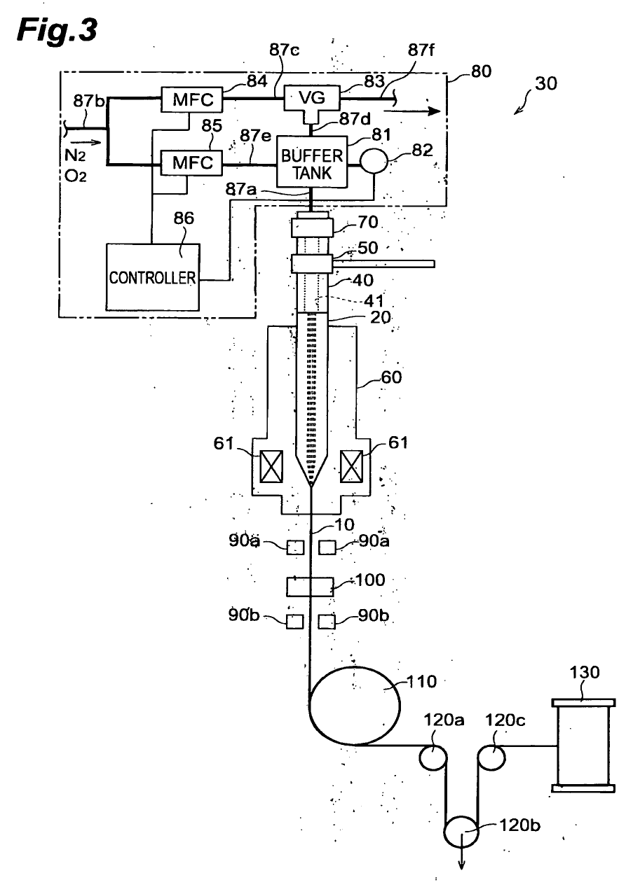

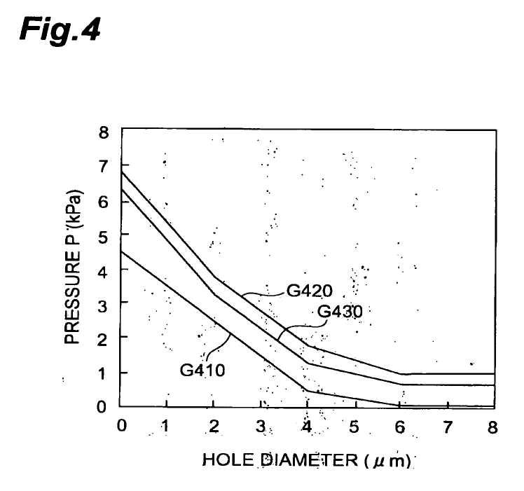

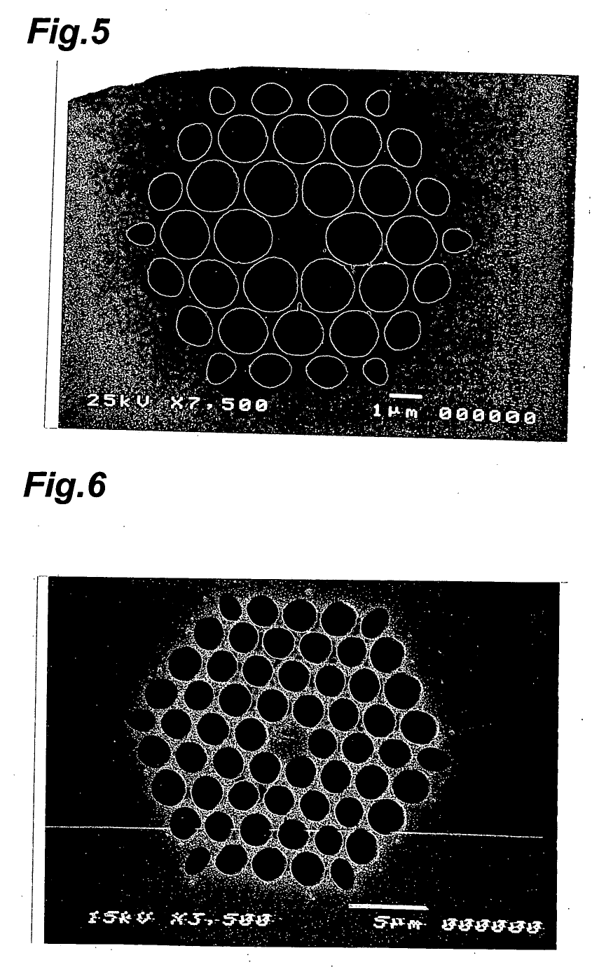

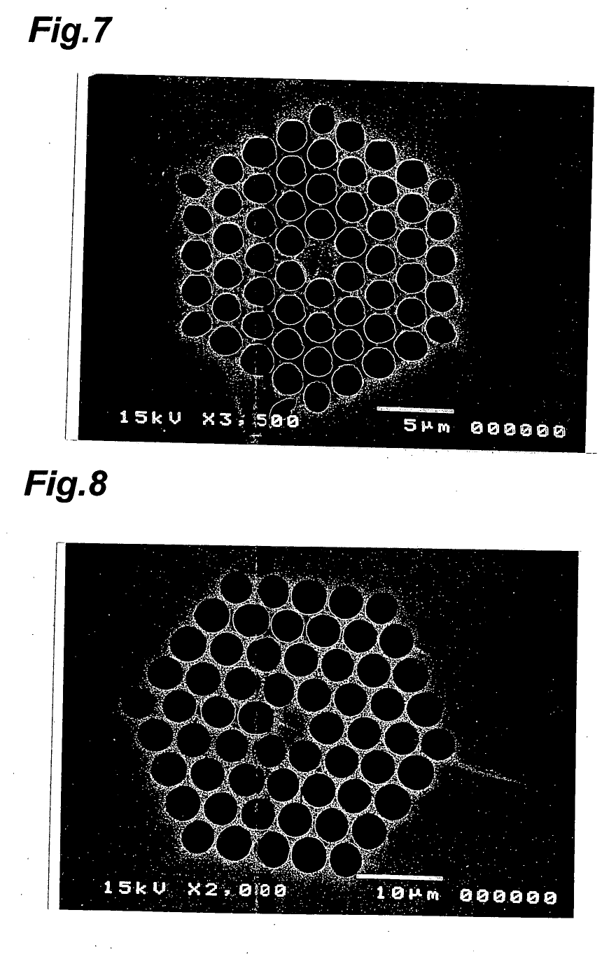

Next, the optical fiber perform 20 is drawn while pressurizing the through holes 23₁ to 23₄ of the optical fiber preform 20. FIG. 3 is a schematic view showing a configuration of the drawing apparatus 30. FIG. 3 shows a process in which the optical fiber preform 20 is drawn by the drawing apparatus 30.

The optical fiber preform 20 has one end connected to a dummy pipe of a hollow cylinder type. The optical fiber preform 20 is kept in the drawing furnace 60 while holding the dummy pipe 40 connected to the one end by the chuck 50.

The diameter (outer diameter) of the dummy pipe 40 is nearly equal to the diameter of the optical fiber preform 20. The inner diameter of the dummy pipe 40 is nearly equal to or slightly larger than the diameter of the circle surrounding the through holes 23₄ arranged so as to constitute the outermost layer in the optical fiber preform 20. The internal space 41 of the dummy pipe 40 is joined to the pressure adjuster 80 via the pressurizing joint 70 which is fixed to the end of the dummy pipe 40 opposite to the optical fiber preform 20. The pressure adjuster 80 applies pressure to the through holes 23₁ to 23₄ of the optical fibber preform 20 through the internal space 41 of the dummy pipe 40 to make the pressure in the through holes 23₁ to 23₄ higher than atmospheric pressure.

The pressure adjuster 80 comprises a buffer tank 81, a differential manometer 82, a vacuum generator (VG) 83, mass flow controllers (MFCs) 84 and 85, and a controller 86. The controller 86 controls the MFCs 84 and 85.

The buffer tank 81 is filled with mixed gas of nitrogen gas and oxygen gas. The buffer tank 81 is connected with the pressurizing joint 70 through the pipe 87a. The pressure is applied to the through holes 23₁ to 23₄ through the inner space 41 of the dummy pipe 40 by adjusting the pressure of the mixed gas in the buffer tank 81.

The pressure in the buffer tank 81 is measured by the differential manometer 82, and adjusted on the basis of the measured value. The method of adjusting the pressure in the buffer tank 81 will be described in more detail.

The differential manometer 82 is electrically connected to the controller 86, and the value measured by the differential manometer 82 is input to the controller 86. The controller 86 controls the MFCs 84 and 85 on the basis of the value measured by the differential manometer 82 to change the pressure in the buffer tank 81.

Into the MFCs 84 and 85, mixed gas of nitrogen gas and oxygen gas is caused to flow through the pipe 87b from the left side in FIG. 3. The mixed gas which has passed through the MFC 84 flows into the VG 83 through the pipe 87c. The VG 83 is connected to the buffer tank 81 through the pipe 87d. On the other hand, the mixed gas which has passed through the MFC 85 flows into the buffer tank 81 through the pipe 87e. An initial gas pressure in the buffer tank 81 is determined by means of the mixed gas which has passed through the MFC 85. In this state, when the controller 86 increases the flow rate of the MFC 84 while keeping the flow rate of the MFC 85 constant, the flow rate of the mixed gas to the pipe 87f disposed at the right side of the VG 83 in FIG. 3 increases. In this case, the pressure in the buffer tank 81 is reduced because the VG 83 and the buffer tank 81 are connected to each other through the pipe 87d. In order to increase the pressure in the buffer tank 81, the flow rate of the mixed gas from the MFC 85 to the buffer tank 81 may be increased or the flow rate of the MFC 84 may be reduced. As described above, the pressure in the buffer tank 81 can be adjusted by changing the flow rate of the MFC 84 or MFC 85. By adjusting the pressure in the buffer tank 81, desired pressure is applied to the through holes 23₁ to 23₄ of the optical fiber preform 20.

The optical fiber preform 20, the through holes 23₁ to 23₄ of which has been pressurized as described above, is drawn while being heated by the heater 61 of the drawing furnace 60 at the other end opposite to the end to which the dummy pipe 40 is fixed.

The outer diameter of the micro-structured optical fiber 10 constituting the drawn optical fiber preform 20 is measured by the outer diameter measuring device 90a at the downstream side of the drawing furnace 60. The outer diameter of the micro-structured optical fiber 10 is about 125 (μm) unless otherwise specified. Next, the micro-structured optical fiber 10 is coated with a resin by the resin coating unit 100. The resin coating unit 100, at first, coats the micro-structured optical fiber 10 with ultraviolet cured resin by the primary coating dies, and cures the ultraviolet cured resin by ultraviolet irradiation. Subsequently, the resin coating unit 100 coats the micro-structured optical fiber 10 with ultraviolet cured resin by the secondary coating dies, and cures the ultraviolet cured resin by ultraviolet irradiation, thus doubly covering the micro-structured optical fiber 10 with ultraviolet cured resin. The outer diameter of the micro-structured optical fiber 10 covered with ultraviolet cured resin by the resin coating unit 100 is then measured by the outer diameter measuring device 90b. The micro-structured optical fiber 10 passes the capstan 110, the roller 120a, the dancer roller 120b, and the roller 120c in order of mention, and then is wound up by the bobbin 130.

Drawing tension and line speed at the drawing are determined by means of the rotational speed of the capstan 110, the load of the dancer roller 121b, and the heating temperature caused by the heater 61 of the drawing furnace 60.

In order to increase the drawing tension without changing the line speed at the case of obtaining a micro-structured optical fiber 10 having the same diameter, the heating temperature for the optical fiber preform 20 caused by the heater 61 of the drawing furnace 60 is reduced. That is why when the heating temperature is low, the viscosity of the optical fiber preform 20 is high, and thereby it is necessary to draw the optical fiber preform 20 by a larger force. On the contrary, in order to reduce the drawing tension without changing the line speed, the heating temperature for the optical fiber preform 20 is increased. That is why when the heating temperature is high, the viscosity of the optical fiber preform 20 is low, and thereby the optical fiber perform 20 can be drawn by a small power.

In this embodiment, the line speed of 30 to 100 (m/min) is adopted. However, if the line speed is up to the order of 400 (m/min), the effect achieved by the method for producing the micro-structured optical fiber 10 in this embodiment does hot change at all. When the line speed is increased without changing the heating temperature of the drawing furnace 60, the drawing tension increases roughly in proportion to the line speed. Thus, in order to increase the line speed while keeping the drawing tension constant, it is necessary to increase the heating temperature of the drawing furnace 60. In this case, although with the reduced viscosity of the glass the through holes 23₁ to 23₄ is liable or easier to deform, time in which the optical fiber preform 20 is kept at a high temperature becomes shorter in proportion to the rise of the line speed. Since the effect obtainable by liability or ease to deform it with reduced viscosity on one hand and the effect obtainable by lack in liability or ease to deform it with reduced time in which it is kept at a high temperature cancel each other, there remains unchanged the liability or ease of deforming the through holes 23₁ to 23₄ regardless of the line speed if the tension is kept constant. Therefore, under the condition of line speed up to the order of 400 (m/min), the effect of the method to be achieved by producing the micro-structured optical fiber 10 of the present embodiment is subject to no change at all. In the case where the line speed is 400 (m/min) or more, the proportionality between the line speed and the drawing tension is not completely applicable so that the effect of keeping it at a high temperature and the effect of the viscosity of it does not completely cancel each other. However, the method to be achieved by producing the micro-structured optical fiber 10 of the present embodiment is sufficiently applicable in this case.

In the drawing apparatus 30, while the pressure adjusting means 80 pressurizes the through holes 23₁ to 23₄ of the optical fiber preform 20 to keep the pressure in the through holes 23₁ to 23₄ higher than atmospheric pressure, the optical fiber preform 20 is drawn by the drawing tension of 0.78 (N) or more, preferably 1.18 (N) or more, more preferably 1.47 (N) or more. In this manner, drawing the optical fiber preform 20 by a larger drawing tension (i.e. drawing it under a lower temperature condition) is equivalent to drawing it under a higher viscosity condition, thereby inhibiting the deformations of the through holes 23₁ to 23₄. In addition, in the case of fabricating a micro-structured optical fiber 10 having the diameter of 125 (μm), the drawing tension is preferably 2.94 (N) (=300 (gf)) or less. That is why breaks of the micro-structured optical fiber 10 can be restrained.

Furthermore, when the through holes 23₁ to 23₄ are pressurized by the pressure adjuster 80 under the condition of the above drawing tension, the pressure P (kPa) (corresponding to a differential pressure to the atmosphere pressure) applied to the through holes 23₁ to 23₄ of the optical fiber preform 20 preferably satisfies the following conditions according to the desired diameters d of the holes 13₁ to 13₄ of the obtained micro-structured optical fiber 10.

In the case of d≦2, the pressure P satisfies the following relationship (15).
−d+4.5<P<−1.5d+6.8 (15)

In the case of 2≦d≦4, the pressure P satisfies the following relationship (16).
−d+4.5<P<−d+5.8 (16)

In the case of 4≦d≦6, the pressure P satisfies the following relationship (17).
−0.2d+1.3<P<−0.4d+3.4 (17)

In the case of 6≦d, the pressure P satisfies the following relationship (18).
0.1<P<1.0 (18)

In the case where the diameter of the micro-structured optical fiber 10 is 100 (μm) or less, the following conditions are preferable.

In the case of d≦2, the pressure P satisfies the following relationship (19).
−d+4.5<P<−1.5d+6.3 (19)

In the case of 2≦d≦4, the pressure P satisfies the following relationship (20).
−d+4.5<P<−d+5.3 (20)

In the case of 4≦d≦6, the pressure P satisfies the following relationship (21).
−0.2d+1.3<P<−0.3d+2.5 (21)

In the case of 6≦d, the pressure P satisfies the following relationship (22).
0.1<P<0.7 (22)

FIG. 4 is a graph showing the above pressure conditions. Between the solid lines G410 and G420 shown in FIG. 4, there is an optimum pressurizing range for fabricating the micro-structured optical fiber 10 having the outer diameter of 125 (μm). In addition, between the solid lines G410 and G430, there is an optimum pressurizing range for fabricating the micro-structured optical fiber 10 having the outer diameter of 100 (μm).

The above pressure conditions are described as follows. In the area (upper part of the heating zone) where the optical fiber preform 20 is started to be heated by the heater 61, the viscosity of the optical fiber preform 20 is small but diameters of the through holes 23₁ to 23₄ are large, so that the influence of surface tension is little. Therefore, the through holes 23₁ to 23₄ expand when being pressurized. Then, when the diameters of the through holes 23₁ to 23₄ become small by drawing the optical fiber perform 20, the through holes 23₁ to 23₄ shrink because the influence of surface tension becomes large. Since the through holes 23₁ to 23₄ becomes the holes 13₁ to 13₄ by fiber drawing, the magnitude of the influence of surface tension in case of the shrinking depends on the diameters d of the holes 13₁ to 13₄. By setting a pressure to be applied to the through holes 23₁ to 23₄ according to diameters of holes 13₁ to 13₄ at a value which satisfies the conditions described above, that is, a value between the solid lines G410 and G420 (or between solid lines G410 and G430) shown in FIG. 4, the expansions and shrinks of the through holes 23₁ to 23₄ can be balanced.

Under the condition that the drawing tension is high, the temperature of the optical fiber preform 20 is low and the viscosity of the glass is high, whereby the through holes 23₁ to 23₄ become not susceptible of any deformation. The forms of the through holes 23₁ to 23₄ are kept to or maintained by canceling the expansions of the through holes 23₁ to 23₄ in the region in which the through holes 23₁ to 23₄ are large in the first half of the drawing, and the shrinks of the through holes 23₁ to 23₄ in the region in which the through holes 23₁ to 23₄ are small in the latter half of the drawing. However, there are exerted greater influences due to the viscosity of the glass in the first half of the drawing than in the latter half of the drawing. Thus, under the condition that the drawing tension is high, there is required a larger pressure to be applied in order to expand the through holes 23₁ to 23₄ by an amount needed in the first half of the drawing. From this reason, the optimum pressure in case where the drawing tension is high becomes high. On the contrary, in the case of the low drawing tension, the optimum pressure for maintaining forms of the holes becomes low.

Therefore, the upper limit value and the lower limit value of the pressure P depend on the drawing tension. The solid line G420 in FIG. 4 represents pressures P in case where the optical fiber preform 20 is drawn by the drawing tension of 2.94 (N). The solid line G410 in FIG. 4 represents pressures P in case where the optical fiber preform 20 is drawn by the drawing tension of 0.78 (N).

With the diameter of the micro-structured optical fiber 10 reduced, the drawing tension per unit area increases. Therefore, in view of inhibiting breakages of the micro-structured optical fiber 10, in the case of fabricating the micro-structured optical fiber 10 having the diameter of 100 (μm), the drawing tension is preferably 1.76 (N) (=180 (gf)) or less. Since the maximum value of the drawing tension becomes smaller (i.e. heated with a higher temperature) like this, in the case where the micro-structured optical fiber 10 having the outer diameter of 100 (μm) is produced, the upper limit value of the optimum pressurizing range is less than that in the case of the outer diameter of 3.25 (μm), as shown in FIG. 4.

Furthermore, in the case where the drawing tension is small, the viscosity of the optical fiber preform 20 is low in the region, at the start of the drawing, in which diameters of the through holes 23₁ to 23₄ are large, and thereby the through holes 23₁ to 23₄ are susceptible of deformation by a small power. Therefore, it is necessary to adjust the pressure P accurately. On the other hand, in the case where the drawing tension is large, the temperature for heating the optical fiber preform 20 becomes lower, so that the viscosity of the optical fiber preform 20 is high. Thus, even if there is a little pressure change, the through holes 23₁ to 23₄ are hard to be deformed. Therefore, it is possible to enlarge the allowable range of the pressure P.

FIGS. 5 to 8 are respectively electron microscope photographs each showing a cross sectional structure orthogonal to the longitudinal direction of the micro-structured optical fiber 10 obtained by drawing the optical fiber perform 20 with drawing tensions of 0.59 (N) (=60 (gf)), 1.08 (N) (=110 (gf)), 1.32 (N) (=135 (gf)), and 1.47 (N) (=150 (gf)) respectively on pressurizing conditions between the solid line G410 and the solid line G420 shown in FIG. 4.

As can be seen from FIG. 5, the outer holes tend to be easier to collapse under the condition that the holes are deformed. Moreover, as can be understood by comparing FIGS. 5 to 8, the higher the drawing tension becomes, the more even the geometric forms become. The reason for this is as follows. When the optical fiber preform 20 is heated in the drawing furnace 60, heat is conducted from the surface to the inside of the optical fiber preform 20. At that time, the through holes 23₄ of the outermost layer act as heat insulating barriers, so that the temperature of the glass on just outside of the through holes 23₄ becomes slightly higher than the temperature of the glass around the inner through holes 23₁ to 23₃. Therefore, the viscosity becomes low and the through holes 23₄ come to exhibit susceptibility of deformation starting from the outermost ones. When the through holes 23₄ of the outermost layer are collapsed to a certain extent to lose functions as heat insulating barriers, the through holes 23₃ of the outer second layer come to act as heat insulating barriers, and hence the through holes are collapsed in order from the outermost ones.

In addition, on a high tension condition, the temperature of the optical fiber preform 20 is low and the viscosity of the glass is high, so that amounts of expansions of the through holes 23₁ to 23₄ in the first half of the drawing, and amounts of shrinks of the through holes 23₁ to 23₄ in the latter half of the drawing are both small. Therefore, differences in deformation amount between the through holes 23₄ of the outermost layer and the inner through holes 23₁ to 23₃ described above become smaller. As shown in FIG. 8, when the optical fiber preform 20 is drawn by the tension of 1.47 (N), all of the holes including the outermost ones are hardly deformed. If the drawing tension is reduced, amounts of expansion of the through holes 23₁ to 23₄ in the first half of the drawing, and amounts of shrink of the through holes 23₁ to 23₄ in the latter half both become larger, so that the differences of deformation amount between the through holes 23₄ of the outermost layer and the inner through holes 23₁ to 23₃ become large. Therefore, as shown in FIGS. 6 and 7, the holes of the outermost layer are collapsed and deformed. Here, it is understood that deformations of the holes of the outermost layer in FIG. 6 with the drawing tension of 1.08 (N) are slightly larger than ones in FIG. 7 with the drawing tension of 1.32 (N).

When the drawing tension is further reduced, the through holes 23₄ of the outermost layer are collapsed to lose functions as heat insulating barriers, so that deformation occurs at the through holes 23₃ of the outer second layer. FIG. 5 shows the case that the optical fiber preform 20 is drawn with the drawing tension of 0.59 (N). In this case, the holes of the outer second layer are also starting to collapse.

FIG. 9 is a graph showing relations between the maximum hole diameter deviation of the holes and drawing tension in each of the micro-structured optical fiber 10 shown in FIGS. 5 to 8. The ordinate axis represents the maximum hole diameter deviation D (%), and the abscissa axis represents drawing tension. In FIG. 9, there are plotted the maximum value P2 out of the maximum hole diameter deviations D of the holes constituting the layer next to the outermost layer, and the maximum value P1 out of the maximum hole diameter deviations D of the holes constituting the outermost layer, regarding to every drawing tension to be measured. As can be seen from FIG. 9, the maximum hole diameter deviations D of the holes of the layer next to the outermost, layer are 10 (%) or less in the case where the drawing tension is 0.78 (N) or more. In addition, the maximum hole diameter deviations D of the holes of the layer next to the outermost layer is 5 (%) or less in case where the drawing tension is 1.18 (N) or more. In the micro-structured optical fiber 10, the geometric forms of the holes constituting the inner layers are easier to exert influences upon the optical transmission characteristic of the micro-structured optical fiber 10. Thus, the smaller the maximum hole diameter deviations D of the holes of the inner layers (i.e. the smaller the deformations), the closer to the design value the optical transmission characteristic is. Therefore, the drawing tension needs to be 0.78 (N) or more, and the drawing tension is preferably 1.18 (N). In the case where the drawing tension is 1.47 (N) or more, the maximum hole diameter deviations D of the holes of the outermost layer is also 10 (%) or less. Consequently, it is understood that the drawing tension is more preferably 1.47 (N).

FIG. 10 is a graph showing a relation between the optimum pressurizing range and the hole diameter. The ordinate axis represents pressures P (kPa) to be applied to the through holes 23₃ to 23₄, and the abscissa axis represents diameters d (μm) of the holes 13₁ to 13₄ of the micro-structured optical fiber 10 to be produced. In FIG. 10, points P4 indicate samples where the maximum hole diameter deviations D of the holes constituting the layer next to the outermost layer are 10% or more, and the points P3 indicates sample where the maximum hole diameter deviations D of the holes constituting the layer next to the outermost layer is 10% or less. Furthermore, in FIG. 10, the solid lines G1010, G1020 and G1030 correspond to the solid lines G410, G420 and G430 in FIG. 4. As can be seen from FIG. 10, in the case where the optical fiber preform 20 is drawn while applying the pressure P which satisfies the above pressure conditions (i.e. conditions between the solid line G1010 and the solid line G1020) to the holes, each of the maximum hole diameter deviations of the holes 13₃ is 10 (%) or less. On the other hand, the maximum hole diameter deviations D of the holes 13₃ of the micro-structured optical fiber 10, which has been produced by applying a pressure outside the optimum pressurizing range, are more than 10 (%). In other words, it can be understood that the deformations of the holes 13₃ are large. From the above, it can be understood that the deformations of the holes 13₃ can be restrained by drawing the optical fiber preform 20 while applying the pressure P in the optimum pressurizing range to the through holes 23₁ to 23₄. The holes 13₁ and 13₂ that exist inside the holes 13₃ can not be deformed easily, and therefore the deformations of the holes 13₁ and 13₂ can be also prevented in the condition that the holes 13₃ are stable.

Next, advantages and effects of the above method of fabricating a micro-structured optical fiber 10 will be explained.

Conventionally, when a micro-structured optical fiber is produced, an optical fiber preform 20 is drawn by the tension 0.49 to 0.74 (N). However, in this embodiment, an optical fiber preform 20 is drawn by the tension of 0.78 (N) or more, preferably 1.18 (N) or more. In other words, in this embodiment, the optical fiber preform 20 is drawn by a high tension while keeping the temperature for heating it lower. Therefore, the deformations of the through holes 23₁ to 23₄ can be restrained in the process of drawing the optical fiber preform 20. As a result, as shown in FIGS. 6, 7, and 8, the deformations of the holes constituting the layers other than the outermost layer are restrained in the micro-structured optical fiber 10. Thus, the optical transmission characteristic can be made closer to the design value. Further, as shown in FIG. 8, when the optical fiber preform 20 is drawn by the drawing tension of 1.47 (N) (=150 (gf)) or more, the deformations of the holes constituting the outermost layer are also restrained. Consequently, the optical fiber preform 20 is more preferably drawn by the drawing tension of 1.47 (N) or more.

Furthermore, at the drawing, the pressure P between the solid lines G410 and G420 (or between the solid lines G410 and G430) shown in FIG. 4 is applied to the through holes 23₁ to 23₄. Therefore, the expansions and shrinks of the through holes 23₁ to 23₄ can be balanced, and thereby the deformations of the holes 13₁ to 13₄ are further restrained.

By the way, under the condition that the drawing tension is reduced as shown in FIG. 5, when a large pressure is applied to the holes in order to keep to the diameters of the holes of the layer which is the second from outside, the holes of the inner layers expand too much. On such a low-tension condition, no matter how the pressure is changed, not all of the holes can be made even. Thus, it is important to select an optimum pressurizing condition meeting a requirement of a desired hole diameter d in such a state wherein the drawing tension is 0.78 (N) or more.

In this embodiment, the pressure P to be applied to the through holes 23₁to 23₄ is optimized depending on the diameter of the holes 13₁ to 13₄ of the micro-structured optical fiber 10. Therefore, the expansions and shrinks of the through holes 23₁ to 23₄ are enabled to be balanced also in the through holes 23₁ to 23₄ constituting a layer structure, so that the maximum hole diameter deviations D of the holes of the layer which is the second from outside can be reduced as shown in FIGS. 6 and 7, and the deformations of the holes of the outermost layer can be also reduced as shown in FIG. 8.

In the case of fabricating the micro-structured optical fiber 10, in which holes are distributed in such a manner that d/Λ shown in FIG. 1 is 0.5 or more, that is, in the case of fabricating the micro-structured optical fiber 10 in which space between adjacent holes is narrow, adjacent through holes are liable to push one another with the result that the through holes 23₁ to 23₄ become susceptible of deformation, when the through holes 23₁ to 23₄ expand in the first half of the drawing. Like the above fabricating method, there can be fabricated a micro-structured optical fiber in which any deformation of the holes 13₁ to 13₄ are restrained, by optimizing the pressure while keeping the drawing tension of 0.78 (N) or more, even in the case where it has such a structure having the d/Λ of 0.5 or more that the through holes are susceptible of deformation. In the method of fabricating the micro-structured optical fiber 10 in this embodiment, an improved micro-structured optical fiber 10 can be obtained, even if it has a structure having a larger d/Λ, by fabricating it under the condition that the drawing tension is large (condition near the solid line G420 or G430, in FIG. 4).

In the foregoing, a preferred embodiment of the present invention is explained in detail. However, it is needless to say that the present invention is not limited to the above embodiment. For example, in the above embodiment, the holes 13₁ to 13₄ are arranged so as to constitute a layered structure having four layers each having the form of a hexagonal lattice in a cross section orthogonal to the longitudinal direction of the micro-structured optical fiber. However, it is not necessary to dispose them particularly in such a manner. For example, the holes might have only to constitute three or more layers. Furthermore, the arrangement of the holes 13₁ to 13₄ in a cross section orthogonal to the longitudinal direction may only be such a one needed to achieve a characteristic to be realized by a micro-structured optical fiber, e.g. a chromatic dispersion having a large absolute value, or an effective area larger or smaller than that of an optical fiber having no hole.

Furthermore, a dopant (e.g. Ge) for increasing the refractive index or a dopant for reducing the refractive index may be added to the core region 11. No additives may be added to the core region 11. The core region 11 may be hollowed.

In this embodiment, the diameter of the micro-structured optical fiber 10 to be fabricated is set at 125 (μm), but is not necessarily limited particularly to 125 (μm). In addition, the diameter of the optical fiber preform 20 is 25 (mm), but is not always 25 (mm). For example, the diameter may be 36 (mm), 70 (mm), or the like. However, an optical fiber preform having a diameter larger than 25 (mm) is affected by the effect in that the through holes are collapsed by surface tensions, until the diameter changes from 36 (mm) or 70 (mm) to 25 (mm), opposing to an optical fiber preform having the diameter of 25 (mm). Although the pressurizing condition is optimized so as to cancel this effect, adjacent through holes push one another if the deformations of the through holes are large as described above, possibly causing deformation. Therefore, an optical fiber preform is preferably drawn by a high tension for further reducing the amounts of the deformations of the through holes. On the contrary, when the diameter of the preform is reduced to 15 (mm), the fabrication for a micro-structured optical fiber becomes easy because the influence such that surface tension collapses the through holes is weakened.

Furthermore, in this embodiment, in the formulas (13) and (14), when d_{A} corresponds to the mean value δ_{A} of the maximum hole diameters d_{MAX} and minimum hole diameters d_{MIN} of the holes 13₁ to 13₄, each of the first deviations Δ₁ and second deviations δ₂ of the holes 13₁ to 13₄ may be 10 (%) or less. In this case, the optical transmission characteristic can be made closer to the design value.

In accordance with the present invention, an optical fiber has a plurality of holes arranged so as to satisfy the specific conditions in the cross section orthogonal to the longitudinal direction thereof, and therefore the optical transmission characteristic can be made closer to the design value.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A method of fabricating an optical fiber having a plurality of holes extending along a longitudinal direction thereof, comprising the steps of:
preparing an optical fiber preform having a plurality of through holes intended to serve as the holes;
drawing said optical fiber preform by the drawing tension of 0.78 (N) or more while pressurizing the inside of the through holes of said optical fiber perform prepared.

2. A method according to claim 1, wherein said optical fiber preform is drawn by the drawing tension of 1.18 (N) or more.

3. A method according to claim 1, wherein, in the case of obtaining an optical fiber with the holes each having a diameter d of 2 (μm) or less, the pressure P (kPa) applied to the perform holes of said optical fiber preform satisfies the following relationship.
−d+4.5<P<−1.5d+6.8

4. A method according to claim 1, wherein, in the case of obtaining an optical fiber with the holes each having a diameter d of 2 (μm) or more but 4 (μm) or less, the pressure P (kPa) applied to the inside of the perform holes of said optical fiber preform satisfies the following relationship.
−d+4.5<P<−d+5.8

5. A method according to claim 1, wherein, in the case of obtaining an optical fiber with the holes each having a diameter d of 4 (μm) or more but 6 (μm) or less, the pressure P (kPa) applied to the inside of the perform holes of said optical fiber preform satisfies the following relationship.
−0.2d+1.3<P<−0.4d+3.4

6. A method according to claim 1, wherein, in the case of obtaining an optical fiber with the holes each having a diameter d of 6 (μm) or more, the pressure P (kPa) applied to the inside of the perform holes of said optical fiber preform satisfies the following relationship.
0.1<P<1.0

7. A method according to claim 1, wherein said optical fiber preform is drawn with the drawing tension of 1.76 (N) or less in such a manner that a fiber diameter after drawing becomes 100 (μm) or less.

8. A method according to claim 7, wherein, in the case of obtaining an optical fiber with the holes each having a diameter d of 2 (μm) or less, the pressure P (kPa) applied to the inside of the perform holes of said optical fiber preform satisfies the following relationship.
−d+4.5<P<−1.5d+6.3

9. A method according to claim 7, wherein, in the case of obtaining an optical fiber with the holes each having a diameter d of 2 (μm) or more but 4 (μm), the pressure P (kPa) applied to the inside of the perform holes of said optical fiber preform satisfies the following relationship.
−d+4.5<P<−d+5.3

10. A method of claim 7, wherein, in the case of obtaining an optical fiber with the holes each having a diameter d of 4 (μm) or more but 6 (μm) or less, the pressure P (kPa) applied to the inside of the perform holes of said optical fiber preform satisfies the following relationship.
−0.2d+1.3<P<−0.3d+2.5

11. A method according to claim 7, wherein, in the case of obtaining an optical fiber with the holes each having a diameter d of 6 (μm) or more, the pressure P (kPa) applied to the inside of the perform holes of said optical fiber preform satisfies the following relationship.
−0.1<P<−0.7

12. An optical fiber comprising:
a core region extending along a longitudinal direction of said optical fiber;
a cladding region provided on an outer periphery of said core region; and
a plurality of holes provided in at least one of said core region and said cladding region and extending along the longitudinal direction, said holes arranged so as to constitute a layered structure having three or more layers in a cross section orthogonal to the longitudinal direction,
wherein, when the maximum diameter and the minimum diameter of each of hole arranged so as to constitute the inner layers except the outermost layer of the layered structure are respectively set to d_{MAX} and d_{MIN}, the mean value of the maximum diameters d_{MAX} and the minimum diameters d_{MIN} of the holes arranged so as to constitute the inner layers is set to d_{A}, the fist deviation of each of the holes arranged so as to constitute the inner layers is set to D₁ (%) as defined by the following formula:
$${D}_{1} = \frac{\vert {d}_{MAX} - {d}_{A} \vert}{{d}_{A}} \times 100 ,$$
and the second deviation of each of the holes arranged so as to constitute the inner layers is set to D₂ (%) as defined by the following formula:
$${D}_{2} = \frac{\vert {d}_{MIN} - {d}_{A} \vert}{{d}_{A}} \times 100 ,$$
both of the first deviation D₁ and the second deviations D₂ of each of the holes arranged so as to constitute the inner circles are 10 (%) or less.

13. An optical fiber comprising:
a core region extending along a longitudinal direction of said optical fiber;
a cladding region provided on an outer periphery of said core region; and
a plurality of holes provided in at least one of said core region and said cladding region and extending along the longitudinal direction, said holes arranged so as to constitute a layered structure having three or more layers in a cross section orthogonal to the longitudinal direction,
wherein, when the maximum diameter and the minimum diameter of each of said plurality of holes are respectively set to d_{MAX} and d_{MIN}, the mean value of the maximum diameters d_{MAX} and the minimum diameters d_{MIN} of said plurality of holes is set to δ_{A}, the fist deviation of each of said plurality of holes is set to Δ₁ (%) as defined by the following formula:
$${Δ}_{1} = \frac{\vert {d}_{MAX} - {δ}_{A} \vert}{{δ}_{A}} \times 100 ,$$
and the second deviation of each of said plurality of holes is set to Δ₂ (%) as defined by the following formula:
$${Δ}_{2} = \frac{\vert {d}_{MIN} - {δ}_{A} \vert}{{δ}_{A}} \times 100 ,$$
both of the first deviation Δ₁ and the second deviation Δ₂ of each of said plurality of holes are 10 (%) or less.
